(19) United States
(12) Patent Application Publication
(10) Pub. No.: US 2023/0033887 A1
(43) Pub. Date: Feb. 2, 2023

(54) DATABASE-PLATFORM-AGNOSTIC PROCESSING OF NATURAL LANGUAGE QUERIES

(71) Applicant: VMWARE, INC., Palo Alto, CA (US)

(72) Inventors: PRIYANKA LUTHRA, Pune (IN); SAI SATWIK KUPPILI, Pune (IN); SHRINIVAS SHARAD PARASHAR, Pune (IN); SARAT CHANDRA ANNADATA, Pune (IN)

(21) Appl. No.: 17/499,901

(22) Filed: Oct. 13, 2021

(30) Foreign Application Priority Data
Jul. 23, 2021 (IN) 202141033186

(51) Int. Cl. G06F 16/2452; G06F 40/40; G06F 16/25

(52) U.S. Cl. CPC G06F 16/24522; G06F 16/24526; G06F 40/40; G06F 16/256

(57) ABSTRACT

Examples herein include systems and methods for processing natural language queries across database platforms. An example method can include storing relational graphs representing relational paths between resources, such as by using nodes and edges. When a user inputs a query in natural language format, the method can identify and extract a matching intent and entity using a natural language understanding tool trained with an automated script. The method can include fetching a relational path and formatting it as an ordered list of nodes and edges. The list can be translated into a framework specific to a first database relevant to the query to obtain a translated path. The translated path can be used to execute the query at the database. Returned results can be displayed as a list of objects on a GUI.

### RELATED APPLICATION

Benefit is claimed under 35 U.S.C. 119(a)-(d) to Foreign Application Serial No. 202141033186 filed in India entitled “DATABASE-PLATFORM-AGNOSTIC PROCESSING OF NATURAL LANGUAGE QUERIES”, on Jul. 23, 2021, by VMware, Inc., which is herein incorporated in its entirety by reference for all purposes.

### BACKGROUND

Databases not only store data, but also allow for searching and retrieval of that stored data. In addition to pulling single data points, databases can also support relational queries. A relational query can be any query about data contained in more than one location, such as data contained in two or more tables of the database. Relational queries typically must specify the relevant tables and the condition linking the data from those tables, such as a matching account number. Relational queries can be difficult for users to craft because they require knowledge of the query language specific to the relevant database and knowledge of the database structure, such as the relevant tables and their associated relationships. Database schemas can be complex, change over time, and differ between products and databases.

Some products enable users to specify their search criteria in natural language. But these products enable only simple queries, such as finding specific objects or objects with certain attributes. Most users greatly prefer natural language queries, as it allows the user to perform queries without learning a query language for the database. However, the functionality of today's natural language query systems does not provide a robust solution in many use cases. These systems are further limited in that they typically only apply to a single type of database, requiring some level of database knowledge when selecting the tool—a query or tool that works with one database type is unlikely to work with a different database type without appropriate modification. If a user wishes to perform natural language searches across two different database types, different tools would be required, and those searches would be limited to simple queries. This leaves a user unable to perform their desired queries without assistance from a subject matter expert, increasing costs and decreasing productivity.

A need therefore exists for systems and methods that allow users to perform more complex queries across different database platforms, without requiring personal knowledge of the database query languages or database types involved with the query.

### SUMMARY

Examples described herein include systems and methods for processing natural language queries across database platforms. An example method can include storing one or more relational graphs. A first relational graph can represent a relational path between a source resource and a target resource, while a second relational graph can represent a reverse relational path between the source resource and the target resource. For example, each relational graph can include nodes representing the resources and an edge representing the relationship between the nodes. In another example, a single relational graph represents both a relational path and a reverse relational path between the source and target resources, such as by including an edge that includes forward and reverse directions. In some examples, a relational graph can include intermediate nodes between the resource nodes, with the intermediate nodes connected to each other by at least one edge representing the relationship between the intermediate nodes. The intermediate nodes can similarly connect to the resource nodes with accompanying edges. Storing these graphs representing the relational path and reverse relational path can allow for searching in both directions, depending on the query received.

In an example method, a computing device can receive a natural language query from a user, such as through a graphical user interface (“GUI”) that allows a user to enter their query in a natural language format. The method can further include identifying a matching intent and entity in the query and extracting them from the query. Identifying the matching intent and entity can be performed by a natural language understanding (“NLU”) tool in some examples. The NLU tool can be trained with a script that automatically generates example training data using a template applied across a plurality of entries in a training database to produce a plurality of training data entries. The template can include placeholders for data types and property values, where generating the example training data is performed by repeatedly replacing the placeholders with data from the training database.

The computing device can make an application programming interface (“API”) call to fetch at least one of the relational path and reverse relational path. The method can also include generating the fetched relational path or reverse relational path as an ordered list of nodes and edges. For example, the nodes can represent the source resource, target resource, or any number of intermediate resources. The edges can join two nodes and represent the relation between those nodes. Where more than two nodes are present, the nodes can be connected by multiple edges with each edge connecting two related nodes.

The example method can also include translating the ordered list of nodes and edges into a framework specific to a first database relevant to the query to obtain a translated path. This can be done by the computing device or some other server. In some examples, this can include identifying a database based on the matching intent and entity from the query or based on other information in the query. The method can include translating the ordered list of nodes and edges into a framework that matches the identified database. In some examples, translating includes generating a query pipeline that includes a chain of queries where the output of a previous query in the chain is used as input for a next query in the chain.

The method can further include executing the query at the first database using the translated path. The executed query can return results, which can be displayed as a list of objects on a GUI of a user device. The list of objects can include information about the objects and allow for user interaction through the GUI to manipulate the list of objects and display or hide information about the objects on the list.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not intended to restrict the claims to any particular examples described herein.

### BRIEF DESCRIPTION OF THE DRAWINGS

FIG. 1 is an illustration of an example system for processing natural language queries across database platforms.

FIG. 2 is an illustration of an example relationship graph used for processing natural language queries across database platforms.

FIG. 3 is an illustration of another example relationship graph used for processing natural language queries across database platforms.

FIG. 4 is a flowchart of an example method for processing natural language queries across database platforms.

FIG. 5 is a sequence diagram of an example method for processing natural language queries across database platforms.

FIG. 6 is an illustration of an example GUI used to perform the various methods described herein.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Examples herein include systems and methods for processing natural language queries across database platforms. An example method can include storing relational graphs representing relational paths between resources, such as by using nodes and edges. When a user inputs a query in natural language format into a computing device, the computing device or another device can identify and extract a matching intent and entity using a natural language understanding tool trained with an automated script. The method can include fetching a relational path and formatting it as an ordered list of nodes and edges. The list can be translated into a framework specific to a first database relevant to the query to obtain a translated path. The translated path can be used to execute the query at the database. Returned results can be displayed as a list of objects on a GUI.

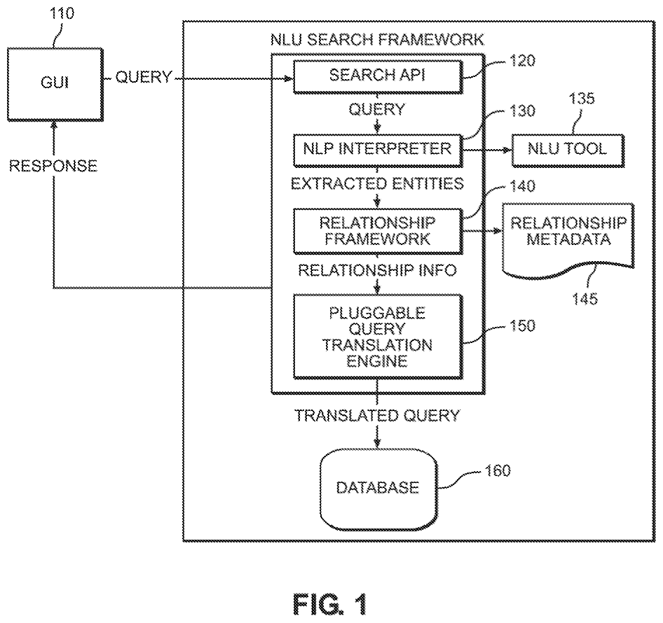

FIG. 1 provides an illustration of an example system for processing natural language queries across database platforms. The system can operate across one or more computing devices that include hardware-based processors and memory storage. Example devices include phones, tablets, laptop and desktop computers, servers, and datacenters. For example, a user can enter a query through their desktop computer and the system can carry out stages at a server, or group of servers, remote from the user.

The system of FIG. 1 includes a graphical user interface (“GUI”) 110 that allows a user to interact with the system. The GUI 110 can execute on a computing device and provide a search interface, such as a text field, in which a user can enter text. The user can enter a search, or query, into the text field using natural language. As an example, if a user wanted to know which virtual machines (“VMs”) were currently connected on a network, the user could enter a natural-language query such as “Virtual Machines on Network.” If the user wanted to limit the list of VMs to those on the network segment relevant to the user, such as Segment A, he or she could enter a natural-language query such as “VMs on Segment A.” As another example, if the user wanted a list of all objects on the network with critical alarms, the user could enter a query such as “Objects with critical alarms.”

The GUI 110 can also provide contextual information that allows a user to determine the context in which the query system operates. For example, if the GUI 110 is a GUI page provided within a larger GUI of a network-administration system, it can include context such as menus, sub-menus, and headers that relate to the network-administration system. This context can communicate to a user that a natural-language query performed on this GUI 110 is likely to be limited to databases relevant to the network-administration system. Similarly, if the GUI 110 is located on an enterprise website available to different types of enterprise employees, the context can indicate that a query will be performed across company databases accessible to those employees.

In some examples, the contextual information is gathered from the query itself. For example, an intent extracted from the query can implicate one or more databases. By extracting the contextual information from the query, the user need not know which databases contain certain types or data, nor does the user need to know how to structure the query. For example, a query can span multiple databases without the user's knowledge.

After the GUI 110 receives a query from the user, it can pass the query to a NLU search framework that includes multiple components. In some examples, the NLU search framework executes on the same computing device upon which the GUI 110 executes. In other examples, the NLU search framework executes on one or more different computing devices, such as servers located remotely from the user's computing device.

In one example, a search API 120 (also referred to herein as an API endpoint) can be utilized to provide the query to a NLU tool 135. In some examples, the search API 120 provides the query to a Natural Language Processing (“NLP”) interpreter 130 that interfaces with the NLU tool 135. The NLP interpreter 130 can provide a layer of abstraction over the underlying NLU tool 135 and can interact directly with the NLU tool 135. For example, the NLU tool 135 can parse a user query and match the content of the query to an intent from similar training data stored in a database, such as training data that uses the same keyword as the user query. That match can be made with a certain confidence level. The extracted entities can also be matched to entities present in training data and can similarly be matched according to a confidence level. The matching process for both intents and entities can be performed using a machine-learning algorithm trained with training data.

The NLP interpreter 130 can then use the intents and entities having a confidence level above a threshold level for further execution. In some examples, the search API 120 and NLP interpreter 130 execute on the same server as part of the NLU search framework. The NLU tool 135 can execute on the same server as well, in some examples, but in some examples the NLU tool 135 can execute on a separate server, such as where the NLU tool 135 is provided by a third-party or where a server is dedicated to NLU computations.

In an example, the search API 120 can be used to provide the language of the query as well as any relevant contextual information, such as which GUI 110 the query was entered through, or any databases specified by the user through the GUI 110. The NLP interpreter 130 can provide additional formatting of this information, if necessary, in order for the NLU tool 135 to be able to process the information.

The NLU tool 135 can be any tool that provides NLU functionality. In some examples, the goal of the NLU tool 135 is to extract structured information from the query. For example, the NLU tool 135 can extract intent, which is the thing the user is trying to convey or goal they are trying to achieve. The NLU tool 135 can also extract entity information, which can include keywords or modifiers related to the intent. In some examples, the NLU tool 135 can be trained in advance using training data relevant to the queries it will receive.

For example, the NLU tool 135 can be trained with user messages such that it better understands future messages from that user or other users in a similar role. In some examples, the training data includes a list of example queries annotated with intents and entities. The example queries can be manually written in a format supported by the NLU tool 135. However, manually crafting each example can be extremely time consuming. To solve this problem, a training data template can be utilized.

The training data template can be a template for specifying the training data to be provided to the NLU tool 135, irrespective of the format supported by the NLU tool 135. A data generation script can convert the template into the format required by the NLU tool 135. In some examples, the template is stored in a format of a data-serialization language, such as a YAML file. The stored template can include example queries categorized by intents, in an example. The stored template can also include lookup tables, regular expressions, and synonyms to improve the intent and entity extraction. Entities such as the resource type, property names, and enumeration-based property values can be specified as lookup tables, while the dynamic property values such as name and IP can be expressed as regular expressions.

The elements included in the stored template can be defined under NLU keys to indicate, for example, the location of lookup table files, regular expression patterns, and example queries, as shown in the pseudocode below:

```
nlu:
  lookup: inventoryResourceTypes
  location: |
    data/inventoryResourceTypes.txt
  regex: words
  pattern: |
    [a-zA-Z0-9_]+
  intent: AssociationIntent
  examples: |
    [l’inventoryResourceTypes’] (InventoryResourceType)
    on [l’12ResourceTypes’] (L2ResourceType)
    [r’words’] (fieldvalue)
```

In some examples, entities are annotated in the example queries. Example annotations can include three syntax types, including (i) [<entity-example>](<entity-type>), (ii) [1′<lookup-table-name>](<entity-type>), and (iii) [r′<regex-name>](<entity-type>).

A training-data-generation script can utilize the template to generate training data. For example, the script can receive the template as input, replace the entity placeholders with the appropriate value from a lookup table or valid value based on a specified regular expression. In one example, syntax of type i is retained as is, while syntax of types ii and iii are handled explicitly. For example, if the syntax is of type ii, it is replaced with an example from <lookup-table-name> and annotated as <entity-type>. Similarly, if the syntax is of type iii, it is replaced with an example generated for the regex <regex-name> and annotated as <entity-type>.

To further illustrate, an example training template can be: [l‘inventoryResourceTypes’](InventoryResourceType) on [1‘12 ResourceTypes’](L2 ResourceType). The resulting training data generated by the training script can be: [VirtualMachine](InventoryResourceType) on [Segment](L2 ResourceType). In this example, “Virtual Machine” and “Segment” are annotated as entities of type InventoryResourceType and L2 ResourceType, respectively. In this example, InventoryResourceType and L2 ResourceType can represent values from a lookup table, such as separate lookup tables for inventory resource types and L2 resource types but could also represent data stored in other formats. In this example, the values pulled from the respective lookup tables are Virtual Machine and Segment.

In addition to the template utilizing entity type and property name placeholders, which can be filled with example entity types and property names, respectively, the template can also include a placeholder for property values. A property value can be any value that describes an aspect of a property aside from the property name. An example template can include a placeholder for property values, which is filled with example property values as part of generating the training data, such as by filling values from a regex that includes relevant property values.

The script can be repeatedly applied in this manner to generate various different sets of training data. This training data can be applied to train the NLU tool 135 such that it learns to analyze messages from a particular user or set of users, based on the training data generated.

The trained NLU tool 135 can receive a query from the search API 120 or NLP interpreter 130 and return structured information from the query. The NLP interpreter 130 can then use the extracted intents and entities having a confidence level above a threshold level for further execution. This further execution can include, for example, passing the information to the relationship framework 140. The relationship framework 140 can be a program, script, code, or software module that executes on a computing device. The relationship framework 140 can execute on the user's computing device in some examples. In other examples the relationship framework 140 executes on a server, such as the server executing the search API 120 or the NLP interpreter 130. However, the relationship framework 140 can also execute on a different computing device that interfaces with the computing devices hosting the other components of FIG. 1.

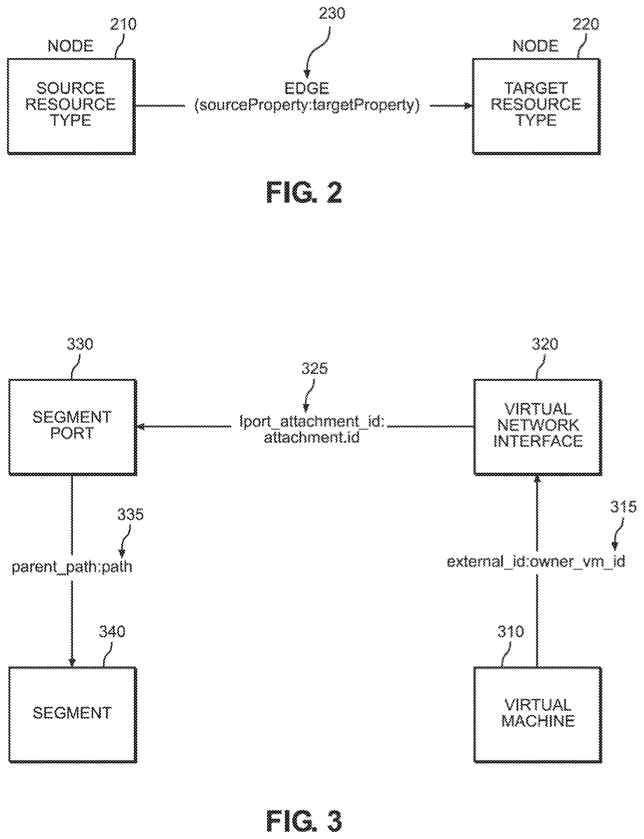

The relationship framework 140 can store relationship information between resource types and provide a mechanism for fetching the relationship information. For example, the relationship framework 140 can store relationship metadata 145. In one example, the relationship metadata 145 is stored in the form of a directed acyclic graph, such as the one shown in FIG. 2. As shown in FIG. 2, an example relationship can have at least two nodes, also referred to as vertices or resources. In the example of FIG. 2, the two nodes represent a source resource type 210 and a target resource type 220. An edge 230 connects the two nodes 210, 220 and represents the relationship between the properties associated with the nodes 210, 220. In the example of FIG. 2, the relationship represented is that the source resource type 210 sourceProperty is equal to the target resource type 220 targetProperty. This is expressed in the drawing as “(sourceProperty:targetProperty).”

The relationship framework 140 can store at least one graph as relationship metadata 145 for each relationship between two properties. In one example, a single graph represents both the forward and reverse relational paths between two nodes. This can be achieved with a graph that includes an edge with arrows pointing in both directions, or with two arrows pointing in either direction. In another example, the relationship framework 140 can store two relational graphs, where one graph can represent the forward relationship while the other represents a reverse path between the same nodes. Storing at least one graph representing both relationship directions can allow a search function to traverse the graphs in both directions, as queries can have interchangeable source and destination types. This can be especially useful for more complex relationship graphs, such as the one shown in FIG. 3. The relationship metadata 145 can be stored in a storage location accessible to the relationship framework 140, such as on the same computing device executing the relationship framework 140. In other examples, the relationship metadata 145 is stored elsewhere, such as on a separate computing device, including a database server that can also execute the database 160 component.

The graph of FIG. 3 includes an example relationship path between a virtual machine node 310 and a segment node 340. As shown, the virtual machine node 310 is connected to a virtual network interface 320 node by an edge 315. That edge 315 provides a relationship between the two nodes 310, 320, which in this example is “external_id:owner_vm_id.” The virtual network interface node 320 is then connected to a segment port node 330 by another edge 325. That edge 325 provides a relationship between the two nodes 320, 330, which in this example is “lport_attachment_ID:attachment.id.” Finally, the segment port node 330 is connected to the segment node 340 by another edge 335. That edge 335 provides a relationship between the two nodes 330, 340, which in this example is “parent_path:path.” The relationship graph of FIG. 3 therefore connects source and target nodes 310, 340 using a path that passes through intermediate nodes 320, 330. In some examples, a path includes more than two other nodes, with no limit on the number of intermediate nodes connecting a source and target node. While the graph of FIG. 3 only shows one direction, in some examples it includes additional edges representing a reverse direction, such as by including arrows pointing in the reverse direction from that shown in the drawing.

Turning back to the relationship framework 140 of FIG. 1, the relationship framework 140 can also include a mechanism for fetching a path between two resource types. For example, the relationship framework 140 can receive an API call that requests the path between a source and destination. An example API call is GetPath (sourceType, destType). Applied to the source and destination nodes of FIG. 3, the example API call would be GetPath (VirtualMachine, Segment). The relationship framework 140 can receive the API call and provide the path. In one example, the path is provided as an ordered list of vertices and edges.

Once the entities have been extracted and the relationship framework 140 has provided the list of vertices and edges, a query translation engine 150 can generate the possible paths between related entities. The translation engine 150 can execute on the user's computing device in some examples. In other examples the translation engine 150 executes on a server, such as the server executing the search API 120, the NLP interpreter 130, or relationship framework 140. However, the translation engine 150 can also execute on a different computing device that interfaces with the computing devices hosting the other components of FIG. 1.

The translation engine 150 can translate the query into a format understood by the underlying system of the relevant database 160. For example, the translation engine 150 can receive input regarding the database relevant to the query. This can be provided based on a selection by the user through the GUI 110, selected by default, selected based on a user group that the user belongs to, or selected based on the subject matter of the query, to name a few examples. Any other mechanism could be used to select the relevant database 160. Once the relevant database 160 is selected, the translation engine 150 can translate the relationship information into a query format suitable for the database 160.

In some examples, the database 160 is located on a computing device separate from the computing devices hosting other components of FIG. 1, such as on a standalone database server. In other examples, the database 160 executes on a computing device, such as a server, that hosts one or more components of FIG. 1, such as the search API 120, NLP interpreter 130, NLU tool 135, relationship framework 140, relationship metadata 145, or translation engine 150.

The translation engine 150 can then execute the translated query at the database 160 and return relevant results. These results can be formatted as desired and displayed to the user at the GUI 110. In one example, the results are provided as an ordered list of objects on the GUI 110. In an example, the results can be sorted based on relevance. The results can also be sorted using any other mechanism, such as by alphanumeric order. In an example where the results list network components with critical alarms, the results can be sorted based on the severity of the alarm, such that the most critical alarms are displayed first while less important results are displayed further down the list. Similarly, the GUI 110 can provide additional tools for sorting the results, such as by customer, business group, or geographic location, to name a few examples.

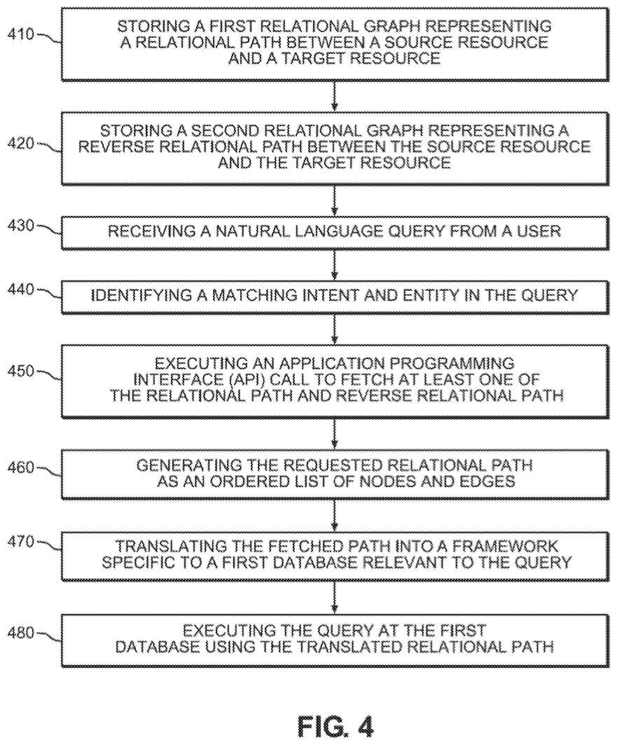

FIG. 4 provides a flowchart of an example method for processing natural language queries across database platforms. Stage 410 of the example method can include storing a first relational graph representing a relational path between a source resource and a target resource. This stage can be performed at a server in an example, such as by the relationship framework 140 described in FIG. 1. The relational graphs can be stored as relationship metadata 145, either in the database 160 described in FIG. 1 or a different database that can be accessed for performing queries. The relationship metadata 145 can also be stored in the memory of a computing device, such as a server or user device.

Example relational graphs are shown in FIGS. 2 and 3 and described above. The relational graphs can include a first node corresponding to a source resource and a second node corresponding to a target resource. The nodes can be connected to each other with an edge describing the relationship between those nodes. In some examples, such as the example shown in FIG. 3, the nodes are connected through other intermediate nodes. Those nodes can similarly connect through edges, such that a chain of nodes and edges connects the source resource to the target resource.

In some examples, the relational graphs are directional, such that they begin at one node and end at another node. The first relational graph stored at stage 410 can therefore represent one direction between nodes. At stage 420, a second relational graph can be stored as relationship metadata 145. The second relational graph can represent a reverse relational path between the source resource and the target resource. In other words, the second relational graph can provide the reverse relationship as the first relational graph with respect to the same source resource and target resource nodes. Storing graphs representing both relationship directions can allow a search function to traverse the graphs in both directions, as queries can have interchangeable source and destination types.

Although the method of FIG. 4 provides separate stages 410, 420 for storing first and second relational graphs, these two stages can also be accomplished by storing a single relational graph representing both the relational path and the reverse relational path between the source resource and target resource. For example, these two stages can include storing a relational graph with edges in both directions between two nodes.

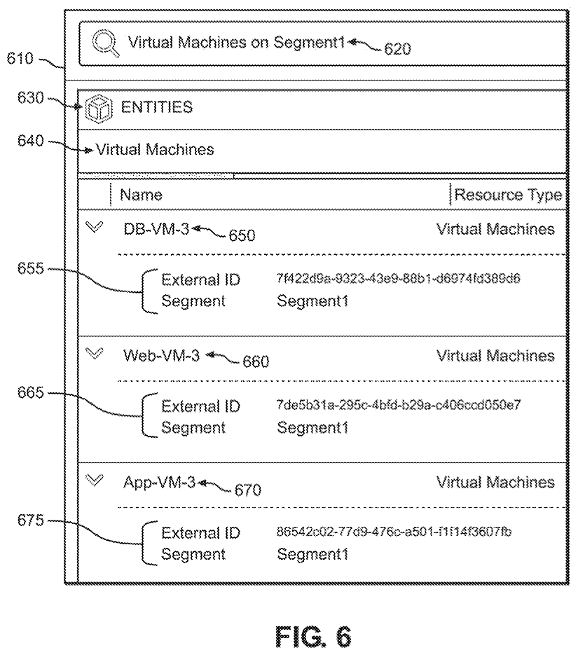

At stage 430, the GUI 110 can receive a natural language query from a user. The user can enter their query into a text field, such as a text field associated with a search interface, as shown in FIG. 6. Stage 430 can also include passing the natural language query to a server executing some of more of the functional modules of FIG. 1, such as by providing the query to an API endpoint such as the search API 120. The search API 120 can then interface with other elements of the system to perform additional stages, such as by providing the query to the NLP interpreter 130.

Stage 440 can include identifying a matching intent and entity in the query. This stage can include the NLP interpreter 130 interfacing with an NLU tool 135 that has been trained to handle relevant natural language queries, such as by being trained with a template that generates training data associated with a user or group of users. The NLU tool 135 can receive the natural language query, parse the query, and tag the matching intent and extracted entities with a certain confidence level. The NLU tool 135 can then return the extracted intents and entities, providing a confidence level for each one.

Stage 450 can include executing, by an API endpoint for example, an API call fetch at least one of the relational path and reverse relational path stored in the first and second relational graphs, respectively, or in a combined relational graph showing both paths. In some examples, this stage includes selecting the desired paths based on selecting one or more intents and entities associated with a confidence level above a threshold, such as a threshold of 95% confidence. The API call can be received by the relationship framework 140 component, which can execute a corresponding search on the stored relationship metadata 145. In one example, the call is a GetPath API call, such as “GetPath (VirtualMachine, Segment),” which would retrieve the path between Virtual Machine and Segment entities. Both the first and second relational graphs (or the combined relational graph) can be searched at this stage to obtain relevant results.

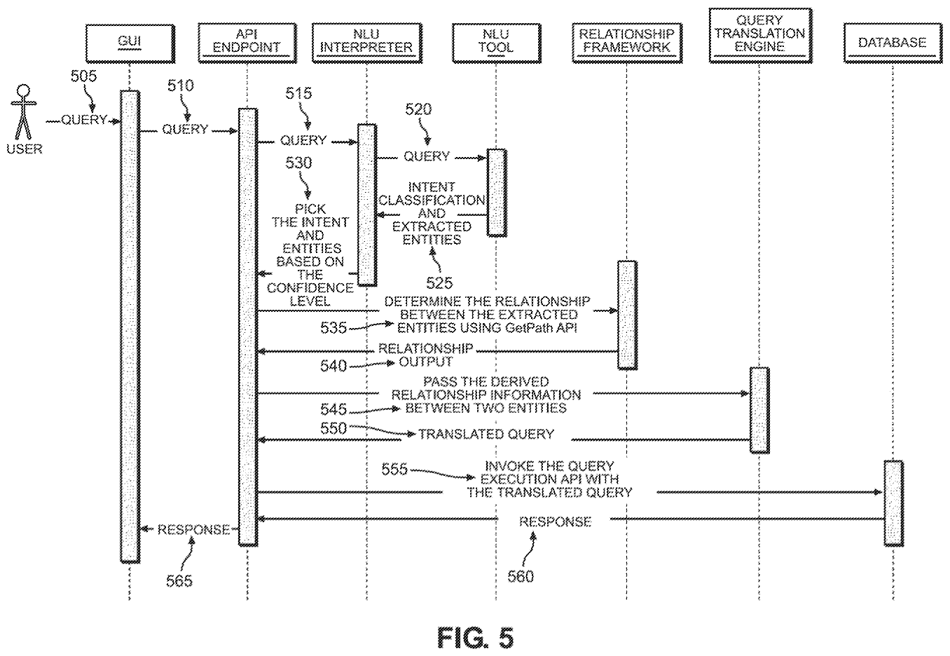

At stage 460, the relationship framework 140 can provide the relevant path as an ordered list of nodes and edges. For example, the results can include a list of nodes, or vertices, such as “VirtualMachine,” “VirtualNetworkInterface,” “SegmentPort,” and “Segment.” The results can also include a list of edges, or joining properties, such as “external_id:owner_vm_id,” “lport_attachment_id:attachment.id,” and “parent_path:path.” These lists of vertices and edges correspond to the relationship graph of FIG. 3, which includes the same vertices and edges in the same directional arrangement. These results are described in more detail with respect to FIG. 5, such as at stage 540 of that drawing.

Stage 470 can include translating the fetched path into a framework specific to a first database relevant to the query. This can include identifying the first database. In some examples, the first database is identified based on the user, such that a query from a user in the IT department implicates an IT-related database, while a query from a user in an accounting department implicates an accounting-related database. In some examples, the user can indicate a database along with the query, such as by selecting from a variety of databases that can optionally be searched.

Stage 470 can also include identifying a query language associated with the first database. Because different database types can have different query languages, the translation engine 150 needs to know which database type is relevant to the query, such that the query can be translated appropriately for that database. This can include translating the ordered list of nodes and edges into an appropriate framework, such as by generating a query pipeline that includes a chain of queries where the output of a previous query in the chain is used as input for a next query in the chain, as discussed in more detail with respect to FIG. 5.

Stage 480 of the example method can include executing the query at the first database using the translated relational path. This can include, for example, executing the query pipeline at the database. Executing the query pipeline can include executing a first query of the pipeline, receiving a result, using that result as input for a second query of the pipeline, and so on, until the query pipeline is completed. Results from the database can be received and provided to the user through the GUI 110, such as with a list of objects as shown and described in FIG. 6.

FIG. 5 provides a sequence diagram of an example method for processing natural language queries across database platforms. At stage 505 of the example method, a user provides a query in natural language format. In this example, the query is “Virtual Machines on Segment1.” The user can enter this query through the GUI 110, as explained above with respect to FIG. 1. At stage 510, the GUI 110 can forward the query to an API endpoint, such as the search API 120. The API endpoint can forward the query the NLU interpreter 130 at stage 515, as shown.

The NLU interpreter 130 can interface with an NLU tool 135, such as an NLU tool 135 that was trained according to the techniques described herein for automated training using a training template. The NLU interpreter 130 can interface with the NLU tool 135 by providing the query at stage 520 in a format understood by the NLU tool 135. For example, the NLU interpreter 130 can invoke a Parse API on the NLU tool 135.

At stage 525, the NLU tool 135 can classify one or more intent of the query and extract entities from the query. As part of stage 525, the NLU tool 135 can return the intent classification and extracted entities to the NLU interpreter 130. In some examples, stage 525 also includes returning a confidence level associated with each intent or entity. An example of the output at stage 525 is provided below:

```
[{
  “entity:“ResourceType”,
  “start”:0,
  “end”:15,
  “confidence_entity”:0.99573799960,
  “value”:“VirtualMachine″
},
{
  “entity”:“fieldvalue”,
  “start”:20,
  “end”:37,
  “confidence_entity”:0.99647730000,
  “value”:“Segment1”
}]
```

In the example above, the NLU tool 135 has extracted two entities. With respect to the “VirtualMachine” input, the NLU tool 135 has extracted an entity of “ResourceType.” This extracted entity includes a confidence score of approximately 0.9957. Similarly, with respect to the “Segment1” input, the NLU tool 135 has extracted an entity of “fieldvalue.” This extracted entity includes a confidence score above 0.9965.

The NLU interpreter 130 can apply a threshold to these results, such as by only selecting entities that are associated with a confidence level above 95%. In the example above, both extracted entities include confidence scores above that threshold level. In another example, For example, the NLU tool 135 can return three different entities for a query, with indications that the first entity has a 99% confidence level, the second entity has an 85% confidence level, and the third entity has a 96% confidence level. In that example, the NLU interpreter 130 would discard the second entity with an 85% confidence level but retain the first entity with a 96% confidence level and the third entity with a 99% confidence level. The same manner of threshold application can be applied to extracted intents returned by the NLU tool 135. In some examples, the NLU interpreter 130 selects the only the intents and entities with the highest confidence level. In other examples, the NLU interpreter 130 selects all intents and entities with a confidence level above the relevant threshold. The NLU interpreter 130 can perform this selection as part of stage 530, which can also include providing the selected intents and entities to the API endpoint for further processing.

In another example, the NLU interpreter 130 can perform additional actions when an intent or entity extracted by the NLU tool 135 is below the confidence threshold. The additional actions to take could depend on the other results from the search. For example, when at least one intent and at least two entities are above the threshold, any remaining intents or entities below the threshold can be ignored until later in the method. When results are displayed on the GUI 110, the GUI 110 can include an identification of the ignored intents or entities that fell below the threshold. For example, the GUI 110 could include text stating “Not shown: [intent2], [entity3],” where “intent2” and “entity3” correspond to an intent and entity falling below a threshold confidence level.

In another example, no intents or entities are returned from the NLU tool 135 with a confidence level above the threshold. In that example, the GUI 110 could display an interactive question to the user that includes the top several matching intents or entities. The interactive question could ask the user whether he or she intended to identify any of these intents or entities. The user can make a selection confirming that one or more (or none) of the listed intents and entities were intended by their query. This confirmation can be used in several ways. First, the method can continue by selecting the confirmed intents or entities, regardless of the confidence level returned by the NLU tool 135. Second, the method can include an additional step of further training the NLU tool 135 based on the feedback from the user. In other words, the NLU tool 135 can learn from its mistakes and better learn that user's natural-language tendencies. This interactive feature can be implemented regardless of how many intents or entities are returned and regardless of their confidence levels.

At stage 535, the API endpoint can determine the relationship between the extracted entities using an API call to the relationship framework 140. This stage can be performed by calling an API of the relationship framework 140, such as a GetPath API. Continuing the same example, the GetPath API can be “GetPath (VirtualMachine, Segment).” The relationship framework 140 can receive the API call and provide the relevant path at stage 540, such as by providing an ordered list of vertices (resource types) and edges (joining properties). An example response to the GetPath API call is provided below:

```
{
  “vertices”: [
    “VirtualMachine”,
    “VirtualNetworkInterface”,
    “SegmentPort”,
    “Segment”
  ],
  “edges”: [
    “external_id:owner_vm_id”,
    “lport_attachment_id:attachment.id”,
    “parent_path:path”
  ]
}
```

This list of vertices and edges corresponds to the relationship graph of FIG. 3, which includes a virtual machine node 310, virtual network interface node 320, segment port node 330, and segment node 340, corresponding to the list of vertices output by the GetPath API above. Similarly, the edges in the relationship graph of FIG. 3 include external_id:owner_vm_id edge 315, lport_attachment_id:attachment.id edge 325, and parent_path:path edge 335, corresponding to the list of edges output by the GetPath API above.

The API endpoint can receive the relationship output at stage 540 can provide it to the query translation engine 150 at stage 545. The query translation engine 150 can also receive an indication of the database type in order to determine how to translate the query appropriately. As mentioned, the database type can be provided according to various mechanisms. For example, the user can select a particular database as part of the query at stage 505, such as by selecting a graphical element corresponding to the database of interest. In another example, the GUI 110 can provide database information based on contextual information. For example, if the GUI 110 is located within a portal available to administrators of a software-defined data center, then the query can automatically be limited to databases relevant to that software-defined data center, rather than all databases across an enterprise. Similarly, if the GUI 110 is provided within a portal associated with financial and accounting practices of an enterprise and is only available to employees within the financial and accounting departments, then the translation engine 150 can receive an indication that the query is to be performed on financial and accounting databases only.

In one example, the database 160 is a NoSQL database with objects stored as JSON documents with no inherent relationship information and no query language available to fetch the related objects. In order to translate the query such that it can be applied to such a database, a query pipeline can be created at stage 550. The query pipeline can be a chain of queries where the output of the previous query is passed as input to the next query. Each query can fetch one resource type and use it to form a join condition with the output of the previous query.

In an example, the query pipeline can be formed with one query per resource type (i.e., vertex/node) and the join condition connecting two resource types is based on the relevant edge information. Returning to the example query of “Virtual Machines on Segment1,” the translation engine 150 can generate a query pipeline that first fetches the segments with Segment 1 as the display name, then uses a subsequent query for Segment Ports connecting to the segments resulting from the previous query. The edge between, explained previously, can state that the SegmentPort's parent_path equals the Segment's path, therefore functioning as the join condition. In other words, the second query would substitute the value of paths obtained from the first query. An example query pipeline using the relationship information from FIG. 3 is provided below:

```
{
  “query_pipeline”: [
    {
      “query”: “resource_type:Segment AND
      → display_name:Segment1”
    },
    {
      “query”: “resources_type:SegmentPort AND
      → parent_path:{path}”
    },
    {
      “query”:
      → “resource_type:VirtualNetworkInterface
      → AND
      → lport_attachment_id:{attachment.id}”
    },
    {
      “query”: “resource_type:VirtualMachine
      → AND external_id:{owner_vm_id}”
    }
  ]
}
```

The example query pipeline shown above is merely one query pipeline that can be created for a particular resource type. In some examples, a query implicates multiple resource types. As an example, multiple resource types can exist with the name “Segment1,” in which case the query will implicate several different resource types with that name. The method can include making an API call to the relevant graph in order to obtain the relationship information for each of those resources. In an example where multiple resources are implicated, multiple query pipelines can be generated with one pipeline corresponding to each resource. For example, if there are three different resources types called “Segment1,” the method can include generating three query pipelines.

The translated query, or queries, can be returned to the API endpoint at stage 550. At stage 555, the API endpoint can invoke a query-execution API associated with the database 160. Invoking the query-execution API can also include providing the translated query to the database 160. The database 160 can execute the translated query at stage 555 and return results to the API endpoint at stage 560. The API endpoint can then pass the results to the GUI 110 at stage 565, where they can be displayed to the user.

An example GUI displayed to a user in response to stage 565 of the sequence diagram of FIG. 5 is provided in the example GUI 610 of FIG. 6. The GUI 610 includes a query field 620, which can be the same field 620 used to enter the original query. In this example, the field 620 retains the query, allowing the user to be reminded of their query while viewing results at the same time. This example GUI 610 follows the example of FIG. 5, showing the query as “Virtual Machines on Segment1” in the query field 620.

The GUI 610 can also include a header 630 that identifies the objects to be listed below. For example, the header 630 includes the word “entities” to indicate that the objects listed below the header 630 are entities returned from the query provided in the query field 620. Below the header 630 is a sub-header 640 that identifies a more specific category of the objects provided below it. In this example, the sub-header 640 includes “Virtual Machines” to indicate that the objects listed below each represent VM entities. In some examples, different entity types are included on the same GUI 610, with multiple sub-headers 640 preceding each group of entity types and identifying them accordingly.

The GUI 610 of FIG. 6 includes a list of three VM entities. In some examples, these entities are listed in order according to a confidence level. In this example, a first VM 650 is listed with the name DB-VM-3, which can correspond to a VM that performs database functionality. Entity information 655 is included for the first VM 650, indicating that the External ID for the first VM 650 is 7f422d9a-9323-43e9-88b1-d6974fd389d6 and the segment upon which the first VM 650 is located is Segment1. This corresponds to the original query which requested virtual machines on Segment 1.

Similarly, the GUI 610 includes a second VM 660 named Web-VM-3, which can correspond to a VM that performs web functionality. Entity information 665 is included for the second VM 660, indicating that the External ID for the second VM 660 is 7de5b31a-295c-4bfd-b29a-c406cccd050e7 and the segment upon which the second VM 660 is located is Segment 1. This result also corresponds to the original query that requested the virtual machines on Segment 1.

Finally, the GUI 610 includes a third VM 670 named App-VM-3, which can correspond to a VM that performs application-related functionality, such as by executing an instance of an application. Entity information 675 is included for the third VM 670, indicating that the External ID for the third VM 670 is 86542c02-77d9-476c-a501-f1f14f3607fb and the segment upon which the third VM 670 is located is Segment 1. As with the other entities 650, 660, the location of the third VM 670 corresponds to the original query requesting the virtual machines on Segment 1.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for processing natural language queries for database platforms, comprising:
storing at least one relational graph representing a relational path and reverse relational path between a source resource and a target resource;
receiving a natural language query from a user;
identifying a matching intent and entity from the query;
executing an application programming interface (API) call to retrieve at least one of the relational path and reverse relational path;
generating the retrieved relational path or reverse relational path as an ordered list of nodes and edges;
translating the ordered list of nodes and edges into a framework specific to a database relevant to the query to obtain a translated path; and
executing the query at the database using the translated path.

2. The method of claim 1, wherein identifying the matching intent and entity is performed by a natural language understanding (NLU) tool, the NLU tool being trained with a script that automatically generates example training data using a template applied across a plurality of data entries.

3. The method of claim 2, wherein the template includes placeholders for entity types and property names, and wherein automatically generating example training data comprises repeatedly replacing the placeholders with data from the plurality of data entries.

4. The method of claim 1, wherein the relational graph includes nodes representing the resources and an edge representing the relationship between the nodes.

5. The method of claim 4, wherein the relational graph includes intermediate nodes between the resource nodes, wherein the intermediate nodes are connected to each other by at least one edge representing the relationship between the intermediate nodes.

6. The method of claim 1, wherein translating the requested relational path comprises generating a query pipeline that includes a chain of queries where the output of a previous query in the chain is used as input for a next query in the chain.

7. The method of claim 1, wherein the relational graph includes a first relational graph representing the relational path and a second relational graph representing the reverse relational path.

8. A non-transitory, computer-readable medium containing instructions that, when executed by a hardware-based processor, performs stages for processing natural language queries for database platforms, the stages comprising:
storing at least one relational graph representing a relational path and reverse relational path between a source resource and a target resource;
receiving a natural language query from a user;
identifying a matching intent and entity from the query;
executing an application programming interface (API) call to retrieve at least one of the relational path and reverse relational path;
generating the retrieved relational path as an ordered list of nodes and edges;
translating the ordered list of nodes and edges into a framework specific to a database relevant to the query to obtain a translated path; and
executing the query at the database using the translated path.

9. The non-transitory, computer-readable medium of claim 8, wherein identifying the matching intent and entity is performed by a natural language understanding (NLU) tool, the NLU tool being trained with a script that automatically generates example training data using a template applied across a plurality of data entries.

10. The non-transitory, computer-readable medium of claim 9, wherein the template includes placeholders for entity types and property names, and wherein automatically generating example training data comprises repeatedly replacing the placeholders with data from the plurality of data entries.

11. The non-transitory, computer-readable medium of claim 8, wherein the relational graph includes nodes representing the resources and an edge representing the relationship between the nodes.

12. The non-transitory, computer-readable medium of claim 11, wherein the relational graph includes intermediate nodes between the resource nodes, wherein the intermediate nodes are connected to each other by at least one edge representing the relationship between the intermediate nodes.

13. The non-transitory, computer-readable medium of claim 8, wherein translating the requested relational path comprises generating a query pipeline that includes a chain of queries where the output of a previous query in the chain is used as input for a next query in the chain.

14. The non-transitory, computer-readable medium of claim 8, wherein the relational graph includes a first relational graph representing the relational path and a second relational graph representing the reverse relational path.

15. A system for processing natural language queries for database platforms, comprising:
a memory storage including a non-transitory, computer-readable medium comprising instructions; and
a computing device including a hardware-based processor that executes the instructions to carry out stages comprising:
storing at least one relational graph representing a relational path and reverse relational path between a source resource and a target resource;
receiving a natural language query from a user;
identifying a matching intent and entity from the query;
executing an application programming interface (API) call to retrieve at least one of the relational path and reverse relational path;
generating the retrieved relational path as an ordered list of nodes and edges;
translating the ordered list of nodes and edges into a framework specific to a database relevant to the query to obtain a translated path; and
executing the query at the database using the translated path.

16. The system of claim 15, wherein identifying the matching intent and entity is performed by a natural language understanding (NLU) tool, the NLU tool being trained with a script that automatically generates example training data using a template applied across a plurality of data entries.

17. The system of claim 16, wherein the template includes placeholders for entity types and property names, and wherein automatically generating example training data comprises repeatedly replacing the placeholders with data from the plurality of data entries.

18. The system of claim 15, wherein the relational graph includes nodes representing the resources and an edge representing the relationship between the nodes.

19. The system of claim 18, wherein the relational graph includes intermediate nodes between the resource nodes, wherein the intermediate nodes are connected to each other by at least one edge representing the relationship between the intermediate nodes.

20. The system of claim 15, wherein translating the requested relational path comprises generating a query pipeline that includes a chain of queries where the output of a previous query in the chain is used as input for a next query in the chain.
